(19) United States
(12) Patent Application Publication
(10) Pub. No.: US 2004/0031416 A1
(43) Pub. Date: Feb. 19, 2004

(54) Fire retardant coating

(76) Inventors: Roderick MacDonald Smart, Alberton (ZA); Willem Johannes Crous, Alberton (ZA)

Correspondence Address: NIXON & VANDERHYE, PC, 1100 N GLEBE ROAD, 8TH FLOOR, ARLINGTON, VA, 22201-4714, US

(21) Appl. No.: 10/276,590

(22) PCT Filed: Jun. 13, 2001
(86) PCT No.: PCT/GB01/02611

(30) Foreign Application Priority Data
Jun. 14, 2000 (ZA) 2000-2988

(51) Int. Cl. C09D 5/16; C09D 5/18; C09K 21/00

(52) U.S. Cl. 106/18.12; 106/626; 106/631; 252/601

(57) ABSTRACT

A solution for forming a fire resistant coating on substrates such as timber comprises an aqueous solution of an alkali metal silicate containing from about 5 to about 70% by weight of the alkali metal silicate and having dispersed therein a filer in an amount of from about 5 to about 60%. The filler is preferably an intumescent material such as a graphite capable of exfoliation. The solution may be applied by brushing or spraying onto timber in a mine to form coatings from 1 to 4 mm in thickness.

### FIELD OF THE INVENTION

This invention relates to a fire retardant.

### BACKGROUND OF THE INVENTION

Underground fires are a major problem in the mining industry. Fires frequently occur in timber packs used as stope support in active and worked out areas, in timber used for cavity filling (or lagging) in cavities above arch sets, and in old timber used as support along haulages and ventilation roads.

Some of the timber is treated with fire retardants. Some treatments comprise dipping or soaking the timber in chemical solutions, sometimes under pressure, to promote ingress of the solutions into the timber. The chemical solutions include sulphates or phenolics containing chemicals known to have fire retarding properties. The intention of the treatments is to achieve a decrease in rate of fire spread, a reduction in heat generation, and a decrease in the potential of the timber to ignite.

The greatest danger from underground fires is from the smoke and toxic gases which may be generated by the fire. Strict limits exist on the combustibility and toxicity of materials for use underground. Fire retardant treatments must not increase the toxicity of smoke and gases generated in a fire. For example, a frequently used chemical in solution for retardancy treatment is ammonium sulphate. Under conditions of high temperature, the ammonium sulphate in the presence of timber has been found to form hydrogen cyanide gas and sulphur dioxide gas. Both of these gases contribute to fume toxicity and are subject to strict statutory limits. Retardant treatments which do not generate additional toxicity hazards are therefore preferred. Known chemical treatments are of limited effectiveness, and none offers a high degree of protection against the spread of fire.

### SUMMARY OF THE INVENTION

According to the invention there is provided a solution for forming a fire retardant coating on a surface which solution comprises a solvent containing from about 5 to about 70% of an alkali metal silicate, the % being based on the combined mass of alkali metal silicate and solvent.

The alkali metal silicate may be sodium silicate, but is preferably potassium silicate.

The solution preferably includes water in which the alkali metal silicate is dissolved. The solution may contain, by mass, more water than alkali silicate. The solution preferably contains from about 20 to 60% of alkali metal silicate and preferably contains from about 35 to about 45% most preferably about 40% of alkali metal silicate the % being by mass based on the combined mass of alkali metal silicate and water.

There may be dispersed in the solution at least one filler preferably in an amount from 5 to 60% more preferably from 10 to 40% by mass of the combined mass of filler, alkali metal silicate and water.

The filler is preferably inorganic. At least one of the fillers is preferably intumescent. The filler is preferably a heat insulator and may be carbon, vermiculite or limestone. The carbon may consist of a mixture of expandable graphite and carbon black. By expandable we mean capable of exfoliating under the action of heat.

The solution may include a thickener for increasing the viscosity of the solution. The thickener may be a water soluble polymer. In one form of the invention the water soluble polymer is hydroxyethyl cellulose.

According to another aspect of the invention a fire retardant coating includes an alkali metal silicate.

The alkali metal silicate may be sodium silicate but is preferably potassium silicate.

The coating may include a filler which is preferably an insulator and inorganic. The filler may be carbon, vermiculite or limestone. The carbon may consist of a mixture of expandable (as herein defined) graphite and carbon black. At least some of the filler is preferably intumescent.

The coating may include a thickener which is preferably a water soluble polymer. The water soluble polymer may be hydroxyethyl cellulose.

The coating may be between 1 and 4 mm thick, and is preferably between 2 and 3 mm thick.

The invention further provides a method of treating a substrate such as timber to improve its fire resistance which method comprises applying to the substrate, conveniently by spraying or brushing, a solution of an alkali metal silicate as hereinbefore defined to form a coating on the substrate preferably from about 1 to about 4 mm in thickness more preferably from about 2 to about 3 nm.

The coating is preferably applied to timber and bonds to the timber.

### DETAILED DESCRIPTION OF AN EMBODIMENT OF HTE INVENTION

A fire retardant solution comprises the following formulation:

| RAW | | | MASS |
|---|---|---|---|
| MATERIAL | GRADE | SUPPLIER | % |
| Potassium Silicate | K2550 | Crossfield (Pty) Ltd | 74.49 |
| Solution | | | |
| Expandable | — | LTM Technology (Pty) | 14.11 |
| Graphite | | Ltd | |
| Carbon Black | Lamp Black 101 | Degussa (Pty) Ltd | 7.06 |
| Hydroxyethyl | Natrosol 250 HR | Bayer SA | 4.34 |
| Cellulose* | | | |
| | | | 100.00 |

*The Hydroxyethyl cellulose is provided as a solution consisting of 11.75% by mass of hydroxyethyl cellulose and 88.25% by mass of water. That is the overall composition contains 0.51% hydroxyethyl cellulose solids.

1. A solution for forming a fire retardant coating on a surface which solution comprises a solvent containing from about 5 to about 70% of an alkali metal silicate the % being by mass based on the combined mass of alkali metal silicate and solvent.

2. The solution of claim 1 wherein the alkali metal silicate is-sodium silicate.

3. The solution of claim 1 wherein the alkali metal silicate is potassium silicate.

4 The solution of any one of the above claims wherein the solvent within which the alkali metal silicate is dissolved is or contains water.

5 The solution of claim 4 wherein the solution contains, by mass, more water than alkali metal silicate.

6 The solution of any one of the preceding claims wherein the solution contains 20% to 60% of alkali metal silicate.

7 The solution of any one of the above claims having dispersed therein at least one filler the amount of filler being from about 5 to about 60% the % being by mass based on the combined mass of filler, alkali metal silicate and solvent.

8 The solution of claim 7 wherein the filler is inorganic.

9 The solution of claim 8 wherein the filler is intumescent.

10 The solution of any one of claims 7 to 9 wherein the filler is carbon.

11 The solution of claim 10 wherein the carbon is a mixture of expandable graphite and carbon black.

12. The solution of any one of claims 7 to 9 wherein the filler is vermiculite.

13 The solution of any one of claims 7 to 9 wherein the filler is limestone.

14 The solution of any one of the above claims including a thickener for increasing the viscosity of the solution.

15. The solution of claim 14 wherein the thickener is a water soluble polymer.

16. The solution of claim 15 wherein the water soluble polymer is hydroxyethyl cellulose.

17. A solution for forming a fire retardant coating on a surface substantially as herein described and exemplified.

18. A fire retardant coating including an alkali metal silicate.

19. The coating of claim 18 wherein the alkali metal silicate is sodium silicate.

20. The coating of claim 18 wherein the alkali metal silicate is potassium silicate.

21. The coating of any one of claims 18 to 20 including a filler.

22. The coating of claim 21 wherein the filler is inorganic.

23. The coating of claim 22 wherein the filler is carbon.

24. The coating of claim 23 wherein the carbon is a mixture of exfoliated carbon and carbon black.

25. The coating of claim 21 wherein the filler is intumescent.

26. The coating of any one of claims 18 to 25 including a thickener.

27. The coating of claim 26 wherein the thickener is a water soluble polymer.

28. The coating of claim 27 wherein the water soluble polymer is hydroxethyl cellulose.

29. The coating of any one of claims 18 to 28 wherein the coating is between one and four millimetres thick.

30. The coating of any one of claims 18 to 29 wherein the coating is applied to a timber surface.
